(19) United States
(12) Patent Application Publication
(10) Pub. No.: US 2016/0178028 A1
(43) Pub. Date: Jun. 23, 2016

(54) CHARGING DEVICE

(71) Applicant: Bosch Mahle Turbo Systems GmbH & Co. KG, Stuttgart (DE)

(72) Inventors: Dirk Lummer, Ludwigsburg (DE); Jochen Gockelmann, Salach (DE); Timo Tries, Weissach/Flacht (DE)

(21) Appl. No.: 14/975,773

(22) Filed: Dec. 19, 2015

(30) Foreign Application Priority Data
Dec. 19, 2014 (DE) 102014226701.3

(51) Int. Cl. F16F 15/04; F16K 21/04; F02B 37/18

(52) U.S. Cl. CPC F16F 15/04; F02B 37/186; F16K 21/04

(57) ABSTRACT

A charging device may include a first component, a second component, and a spring element. The first component may be pre-stressed against the second component by the spring element. The spring element may be in the form of a securing ring which is open in at least one location.

### CROSS-REFERENCE TO RELATED APPLICATIONS

This application claims priority to German Patent Application No. 10 2014 226 701.3, filed Dec. 19, 2014, the contents of which are hereby incorporated by reference in their entirety.

### TECHNICAL FIELD

The present invention relates to a charging device, in particular an exhaust gas turbocharger, with a first component which is prestressed against a second component by means of a spring element. The invention also relates to a spring element for prestressing a first component in relation to a second component.

### BACKGROUND

DE 11 2010 002 024 T5 discloses a charging device of the type in question, in which an axially acting spring element is provided for damping and for reducing wear to the wastegate flap/wastegate lever system. The charging device here comprises a compressor and a turbine, which comprises a turbine housing and a wastegate apparatus with a control flap. The flap plate of the control flap is arranged here via a lever on a control flap shaft which is guided in the turbine housing via a bushing, wherein the flap plate is prestressed against the lever by means of the previously mentioned spring element.

DE 10 2012 101 322 A1 discloses a further charging device with an exhaust gas bypass path which is provided with a bypass valve apparatus which has the following components: a plate-like valve element with a sealing surface and a shaft extending away from the latter, a valve seat for the valve element, the valve seat surrounding an exhaust gas passage opening and interacting with the valve element sealing surface, a valve element carrier, to which the valve element is connected by means of the shaft thereof so as to be movable at least in a direction perpendicularly to the valve element sealing surface, a spindle, which is held rotatably in a bearing bushing, between the valve element carrier and a first region of an adjusting lever running transversely with respect to the spindle, and an adjusting lever actuating element which is pivotably connected to a second adjusting lever region. In order to minimise the wear of such a spring element and also noises which may arise, an annular spring element is provided in the region of the connection between the valve element and the valve element carrier at least at a first position, and/or in the region of the connection between the adjusting lever and the adjusting lever actuating element at a second position.

WO 2014/011468 A1 discloses a further charging device.

However, a disadvantage of the charging devices known from the prior art is that a corresponding spring element which minimises a noise generation already has to be mounted during a joining process, for example of a pin of a flap plate of a wastegate apparatus to a disc, as a result of which it is not possible entirely to exclude the spring element undergoing mechanical and/or thermal preliminary damage.

### SUMMARY

Therefore, the present invention is concerned with the problem of specifying, for a charging device of the type in question, an improved or at least an alternative embodiment which in particular reliably prevents preliminary damage of a spring element.

This problem is achieved according to the invention by the subject matter of independent claims. Advantageous embodiments are the subject matter of the dependent claims.

The present invention is based on the general concept of designing a spring element for prestressing a first component in relation to a second component in the form of a securing ring which is open at one location, in particular in a C-shaped manner, and of thereby making it possible to mount said spring element only after the actual assembly of the two components to each other. The spring element can therefore be shifted in a process step downstream of the actual joining process of the two components, as a result of which possible preliminary damage of the spring element, for example mechanical and/or thermal preliminary damage, can be reliably excluded. Furthermore, it is significantly more easily possible with the spring element according to the invention to observe precise distances between the two components since, according to the process, a measurement is possible, which was possible only with difficulty, if at all, when a previously known, annularly closed spring element was installed. The first component here can be in the form, for example, of a flap plate of a wastegate apparatus, while the second component is in the form of a lever of the wastegate apparatus. In a first working step, it is possible to plug the flap plate by means of the pin thereof through a corresponding through opening in the lever and, on the side opposite the flap plate, to join same to an upset head or to a disc (counter disc) which is braised or welded on. During the welding or braising of the disc to the pin of the flap plate, a not inconsiderable admission of heat into the pin is produced, which signifies a likewise not inconsiderable loading of a spring element already mounted up to now in this process step. In the case of the charging device according to the invention, the joining of the two components, i.e. of the flap plate to the lever, can take place separately, wherein only in a method step subsequent thereto is the spring element, which is open on one side, pushed in from the side between, for example, the disc and the lever and, as a result, the prestressing of the first component in relation to the second component is achieved. Owing to the fact that the spring element designed according to the invention is mounted only after the two components (flap plate and lever) are joined, thermal loading of said spring element can be completely excluded.

In an advantageous development of the solution according to the invention, the spring element is arranged between the flap plate and the lever. An embodiment of this type is conceivable, for example, in the case of a head which is upset on the side opposite the flap plate and merely constitutes an anchoring of the pin on the side opposite the flap plate. In this case, the spring element according to the invention can be simply pushed in from the side between the flap plate and the lever and, as a result, the desired prestressing can be produced. Up to now, the spring element would have already to be mounted before the actual head was upset, as a result of which severe mechanical loading of the spring element during the upsetting of the head could not be excluded. Said severe mechanical loading can now be completely excluded, and this has a particularly advantageous effect on the spring properties of the spring element, since said spring properties are not affected because the mechanical loading is absent.

In an alternative embodiment of the charging device according to the invention, the spring element is arranged between the lever and a disc which is connected to the pin. Said disc is customarily welded, braised, riveted or caulked to the pin, as a result of which a not inconsiderable temperature loading or mechanical loading acts on the pin or on the flap plate. By means of the spring element according to the invention, it is now possible for the first time only to mount said spring element in a process step following the joining, as a result of which thermal and/or mechanical loadings acting up to now on the spring element no longer occur.

As an alternative to the disc which is connected to the pin, the spring element can also engage in a groove which is arranged on the pin and extends around the pin annularly on that side of the lever which is opposite the smooth plate. By means of an embodiment of this type, the disc mentioned in the previous paragraphs can be entirely omitted, as a result of which not only can the diversity of parts be reduced, but also additional assembly costs can be saved.

In a further advantageous embodiment of the solution according to the invention, the first component is in the form of an actuator lever, and the second component is in the form of a wastegate bushing or in the form of a turbine housing. The embodiments of the two components described in the previous paragraphs already make it possible to guess which diverse use possibilities the securing ring, which is open at one location according to the invention, brings therewith in the resilient prestressing of two components.

The spring element is expediently in the form of a disc spring. Disc springs permit particularly high spring forces, which, in the present case, can be optimally used to eliminate noise emissions which would arise, for example, due to rattling of the flap plate.

The invention is furthermore based on the general concept of designing the previously described spring element in the form of a securing ring which is open at one location and, as a result, of being able to provide a completely novel spring element which advantageously opens up the possibility of having to mount said spring element only in a later method step in which the flap plate has already been mounted, since the securing ring can be simply pushed on via the open location thereof.

Further important features and advantages of the invention emerge from the dependent claims, from the drawings and from the associated description of the figures with reference to the drawings.

It goes without saying that the features mentioned above and those which have yet to be explained below are useable not only in the respectively stated combination, but also in different combinations or by themselves without departing from the scope of the present invention.

Preferred exemplary embodiments of the invention are illustrated in the drawings and are explained in more detail in the description below, wherein identical reference signs refer to identical or similar or functionally identical components.

### BRIEF DESCRIPTION OF THE DRAWINGS

In this case, in each case schematically,

FIG. 1 shows a sectional illustration through a wastegate apparatus of a charging device according to the invention,

FIG. 2 shows an illustration as in FIG. 1, but in the case of a different embodiment of a pin,

FIG. 3 shows a top view of FIG. 2,

FIG. 4 shows a top view of a spring element according to the invention,

FIG. 5 shows a sectional illustration through the spring element shown according to FIG. 4.

### DETAILED DESCRIPTION

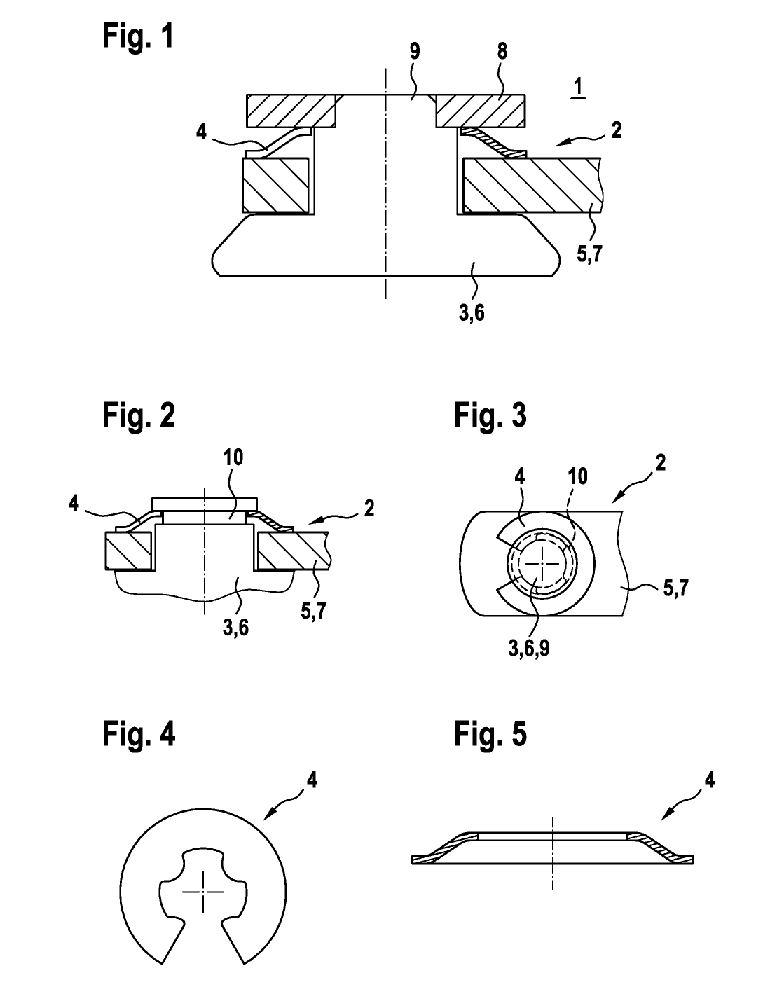

According to FIG. 1, a charging device 1 according to the invention, of which only an excerpt of a wastegate apparatus 2 is shown, has a first component 3 which is prestressed against a second component 5 by means of a spring element 4. In the present case, the first component 3 is in the form of a flap plate 6 whereas the second component 5 is in the form of a lever 7 of the wastegate apparatus 2. Of course, the designations “first and second component 3, 5” are intended here to be representative of components which are generally braceable against one another via a spring element 4 according to the invention, and therefore the first component 3 can also be in the form of an actuator lever, and the second component 5 can be in the form of a wastegate bushing or in the form of a turbine housing.

According to the invention, the spring element 4 is now in the form of a securing ring which is open at one location and has here a substantially C-shaped design, which can be seen particularly readily in the illustration in FIG. 4. By means of the C-shaped design of the spring element 4 according to the invention, it is possible also to mount the latter only after the first component 3 is joined to, for example, a disc 8 (compare FIG. 1), which was not possible up to now in the case of a closed annular design of the spring element. By means of the possibility of the subsequent assembly, in particular the high mechanical and/or thermal loadings occurring during the joining of the disc 8 to the flap plate 3 can be avoided.

Looking at FIG. 1, it can be seen that the spring element 4 is arranged between the lever 5 and the disc 8 which is connected to a pin 9 of the flap plate 3. The disc 8 can be welded, caulked, braised or else also riveted here to the pin 9.

Alternatively thereto, it is also conceivable for the spring element 4 to engage in a groove 10 arranged on the pin 9, as can be seen, for example, in FIGS. 2 and 3. In this case, both disc 8 and also the comparatively complicated assembly thereof can be omitted, as a result of which advantages in respect of the production costs and the production time can be achieved. The spring element 4 itself is customarily formed from spring steel and, furthermore, is, for example, in the manner of a disc spring, which can be seen particularly clearly from FIG. 5. By this means, comparatively high spring forces can be achieved. As spring steel for the spring element 4, use can be made, for example, of a high-alloy spring steel, in particular of a nickel-based alloy. The installation of the spring element 4 according to the invention proves comparatively simple here since said spring element merely has to be correspondingly pushed in around the pin 9 and into the groove 10 after the first component 3 is mounted on the second component 5. In an embodiment as a disc spring, particularly high axial forces can also be applied to the pin 9 and to the flap plate 6. Purely theoretically, it is, of course, also conceivable for the spring element 4 to be arranged between the flap plate 6 and the lever 7, i.e. on the same side of the lever 7 as the flap plate 6.

1. A charging device comprising a first component, a second component, and a spring element, the first component being prestressed against the second component by the spring element, wherein the spring element is in the form of a securing ring which is open in at least one location.

2. A charging device according to claim 1, wherein the first component is in the form of a flap plate of a wastegate apparatus, and the second component is in the form of a lever of the wastegate apparatus.

3. A charging device according to claim 2, wherein the spring element is arranged between the flap plate and the lever.

4. A charging device according to claim 2, wherein the spring element is arranged between the lever and a disc which is connected to a pin of the flap plate.

5. A charging device according to claim 4, wherein the disc is one of welded, braised, caulked or riveted to the pin.

6. A charging device according to claim 1, wherein the spring element engages in a groove arranged on a pin of the first component.

7. A charging device according to claim 1, wherein the first component is in the form of an actuator lever, and the second component is in the form of a wastegate bushing or in the form of a turbine housing.

8. A charging device according to claim 1, wherein the spring element is in the form of spring steel.

9. A charging device according to claim 1, wherein the spring element is in the form of a disc spring.

10. A spring element for prestressing a first component in relation to a second component of a charging device, comprising a securing ring which is open at one location.

11. A charging device according to claim 2, wherein the spring element engages in a groove arranged on a pin of the flap plate.

12. A charging device according to claim 3, wherein the spring element engages in a groove arranged on a pin of the flap plate.

13. A charging device according to claim 2, wherein the spring element is in the form of spring steel.

14. A charging device according to claim 2, wherein the spring element is in the form of a disc spring.

15. A charging device according to claim 7, wherein the spring element is in the form of spring steel.

16. A charging device according to claim 7, wherein the spring element is in the form of a disc spring.

17. A charging device according to claim 8, wherein the spring element is made of a nickel-based alloy.

18. An exhaust gas turbocharger comprising:
a wastegate apparatus having a flap plate and a lever, the flap plate having a pin and a groove arranged on the pin; and
a securing ring configured to prestress the flap plate against the lever, the securing ring being arranged between the flap plate and the lever and engaging in the groove, the securing ring being open in at least one location.

19. An exhaust gas turbocharger according to claim 18, wherein the securing ring is in the form of spring steel.

20. An exhaust gas turbocharger according to claim 18, wherein the securing ring is in the form of a disc spring.
